(19) United States
(12) Patent Application Publication
(10) Pub. No.: US 2020/0283139 A1
(43) Pub. Date: Sep. 10, 2020

(54) HYBRID ROTOR PROPULSION FOR ROTOR AIRCRAFT

(71) Applicant: Bell Helicopter Textron Inc., Fort Worth, TX (US)

(72) Inventors: Albert G. BRAND, North Richland Hills, TX (US); Eric Albert SINUSAS, Southlake, TX (US)

(73) Assignee: Bell Helicopter Textron Inc., Fort Worth, TX (US)

(21) Appl. No.: 16/294,349

(22) Filed: Mar. 6, 2019

(51) Int. Cl. B64C 27/82; B64C 27/12

(52) U.S. Cl. CPC B64C 27/82; B64C 2027/8254; B64C 2027/8209; B64C 27/12

(57) ABSTRACT

A hybrid rotor propulsion system includes a motor having a rotational output connected to a rotor and a prime mover connected to the motor through a rotational input, the prime mover configured to apply a rotational input speed to the motor.

### TECHNICAL FIELD

This disclosure relates in general to the field of aircraft, and more particularly, to a hybrid aircraft rotor propulsion system.

### BACKGROUND

This section provides background information to facilitate a better understanding of the various aspects of the disclosure. It should be understood that the statements in this section of this document are to be read in this light, and not as admissions of prior art.

Conventionally powered rotorcraft, such as helicopters and tiltrotors, are driven by a combustion engine mechanically transmitting power to the rotors. In some rotorcraft, the rotor's mechanical drive system is replaced with direct drive electric motor systems. In hybrid rotorcraft designs, a combustion engine may drive a main rotor while a separate electric system is used to drive one or more anti-torque rotors. This approach can be used to improve rotorcraft propulsion systems, for example, to reduce noise, reduce weight, or to improve safety.

### SUMMARY

An exemplary aircraft rotor propulsion system includes a motor having a rotational output connected to a rotor and a prime mover connected to the motor through a rotational input, the prime mover configured to apply a rotational input speed to the motor.

An exemplary method of controlling a rotational speed of an aircraft rotor includes applying a rotational input speed from a prime mover to a motor and applying a rotational output speed from the motor to the aircraft rotor.

Another exemplary method of controlling a rotational speed of an aircraft rotor includes applying, from a prime mover, a rotational input speed through a drive shaft to a motor and applying a rotational output speed to an anti-torque rotor through the motor.

This summary is provided to introduce a selection of concepts that are further described below in the detailed description. This summary is not intended to identify key or essential features of the claimed subject matter, nor is it intended to be used as an aid in limiting the scope of claimed subject matter.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIG. 1 illustrates an exemplary aircraft implementing an exemplary hybrid tail rotor propulsion system according to one or more aspects of the disclosure.

FIG. 2 illustrates an exemplary aircraft implementing another exemplary hybrid tail rotor propulsion system according to one or more aspects of the disclosure.

FIG. 3 illustrates an aircraft rotor implementing an exemplary hybrid aircraft rotor propulsion system.

FIG. 4 illustrates another aircraft rotor implementing an exemplary hybrid propulsion system.

### DETAILED DESCRIPTION

It is to be understood that the following disclosure provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

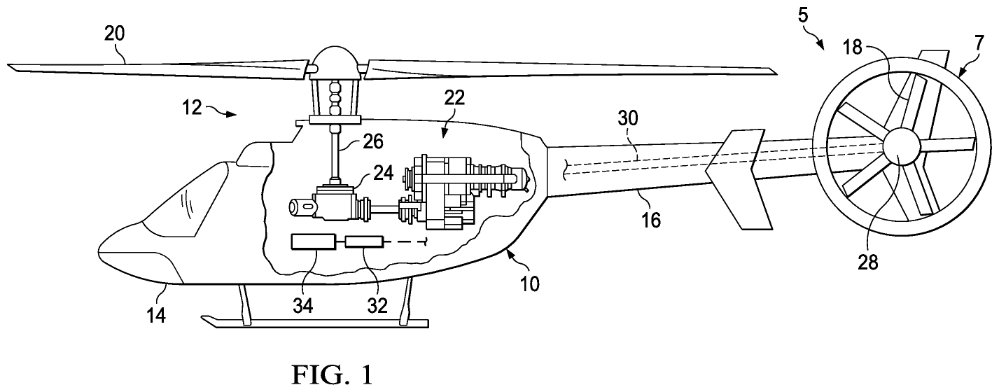

FIG. 1 illustrates an exemplary vertical takeoff and landing (VTOL) rotary aircraft 10 incorporating an exemplary hybrid mechanical-electric tail rotor propulsion system 5. Aircraft 10 includes a rotor system 12, a fuselage 14, and a tail boom 16 carrying an anti-torque system represented by rotor 18 and shroud 7. Rotor system 12 includes rotor 20 having multiple blades for creating flight. Rotor system 12 may include a control system for selectively controlling the pitch of each blade of rotor 20 to control direction, thrust, and lift of aircraft 10. Tail boom 16 may include one or more rotors 18. Rotor 18 generally provides thrust to counter the torque due to the rotation of rotor 20. In an exemplary embodiment, the pitch of rotor 18 is fixed. Teachings of certain embodiments recognize that rotor 18 may represent one example of a rotor or anti-torque rotor; other examples include, but are not limited to, tail propellers, ducted tail rotors, and ducted fans mounted inside and/or outside the aircraft. The anti-torque system may include two or more rotors 18, with or without a shroud, such as in a distributed anti-torque system. Teachings of certain embodiments relating to rotors and rotor systems may apply to rotor system 12 and other rotor systems, such as distributed rotors, tiltrotor, tilt-wing, and helicopter rotor systems. It should be appreciated that teachings herein apply to manned and unmanned vehicles and aircraft including without limitation airplanes, rotorcraft, hovercraft, helicopters, and rotary-wing vehicles.

Aircraft 10 includes a prime mover 22 mechanically connected to a transmission 24 and transmission 24 is mechanically connected to rotor 20 through mast 26. Prime mover 22 may be a combustion engine or an electric motor. In this example, tail rotor 18 is a hybrid propulsion driven rotor operationally connected to prime mover 22 and a motor 28. Motor 28 may be an electric, hydraulic or pneumatic motor. Motor 28 is an electric motor in FIG. 1. In an exemplary embodiment, prime mover 22 an electric motor 22 positioned proximate the center of gravity of aircraft 10 and motor 28 is an additional electric motor.

Prime mover 22 is mechanically connected to a housing or base of motor 28 via a rotational input, e.g., drive shaft 30, to provide a rotational input speed to the housing or base of motor 28 and motor 28 provides further rotational output to rotor 18. In an exemplary embodiment, an electrically driven shaft of motor 28 is connected to tail rotor 18, whereby motor 28 can change the tail rotor speed relative to the rotational input speed from prime mover 22. As an electric drive riding on a mechanical drive, typical low power demand flight conditions can result in a generator state for electric motor 28. The hybrid rotor propulsion system is described herein with reference to an anti-torque tail rotor for the purpose of illustration and with the understanding that the hybrid rotor propulsion system can be utilized with other aircraft rotors, including without limitation main rotors.

Motor 28 is operationally connected to a power source 32, e.g. batteries, and a controller 34. Electric motor 28 may be controlled by controller 34 over a range of speeds in response to a pilot and/or flight control system. Controller 34 can include logic to control the rate of rotation of rotor 18 via electric motor 28. Controller 34 may be included for example in the motor controller or the flight computer, be a component of the motor controller or the flight computer, and/or be in communication with the motor controller or the flight computer.

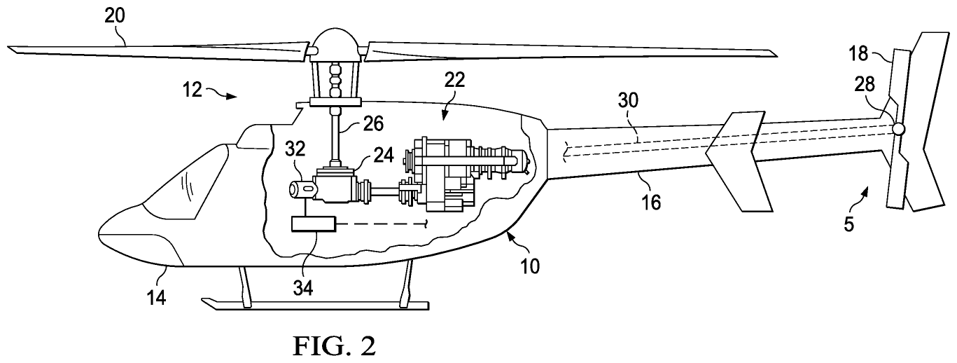

FIG. 2 illustrates another exemplary vertical takeoff and landing (VTOL) rotary aircraft 10 incorporating a hybrid rotor propulsion system 5. In this example, motor 28 is a hydraulic motor that may be driven by a hydraulic pump 32. Prime mover 22 may be a combustion engine or an electric motor.

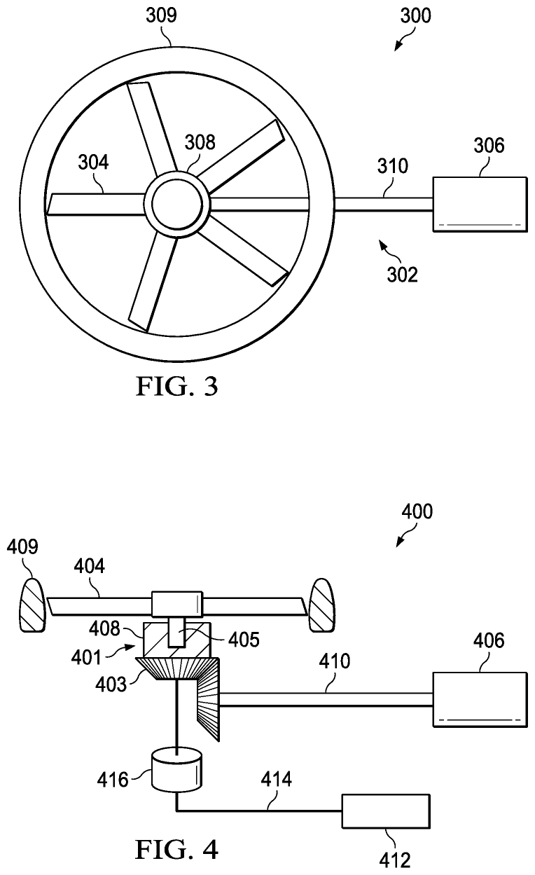

FIG. 3 illustrates an exemplary aircraft tail rotor 300 implementing an exemplary hybrid rotor propulsion system 302. Aircraft tail rotor 300 includes one or more blades 304 within a shroud 309. Rotor 300, e.g., blades 304, is operationally connected to a prime mover 306 and a motor 308. Prime mover 306 may be for example a combustion engine or an electric motor and motor 308 may be an electric, hydraulic, or pneumatic motor. Prime mover 306 is operationally connected through a rotational input, e.g., drive shaft 310, to motor 308 and motor 308 is operationally connected through a rotational output to rotor 300. The rotational input may be connected for example to a motor housing, motor base, or motor shaft and the rotor may be connected to one of the other of the motor housing, the motor base, or the motor shaft.

FIG. 4 illustrates another exemplary aircraft rotor 400 utilizing a hybrid rotor propulsion system 402. Aircraft rotor 400 includes one or more blades 404, for example within shroud 409. Rotor 400, e.g., blades 404, are operationally connected to a prime mover 406, e.g., a combustion engine or electric motor, and a motor 408, e.g., electric, hydraulic or pneumatic motor. Prime mover 406 is connected to motor 408 through a rotation input. In FIG. 4, prime mover 406 is operationally connected to rotor 400 via drive shaft 410 and gears 403, e.g., bevel gears. Prime mover 406 provides rotational mechanical shaft power to drive shaft 410 and gears 403 to supply a rotational input speed to motor 408.

A power source 412, e.g., battery, generator, or hydraulic pump, is operationally connected to motor 408 via a line 414 and a slip ring 416. A portion, e.g., rotor or stator, of motor 408 is connected to the rotational input from prime mover 406 and the other portion, e.g., stator or rotor, of motor 408 is connected as the rotational output to rotor 400. For example, in FIG. 4 motor housing or base 401 is fixed to drive shaft 410, for example through gears 403 and rotates with drive shaft 410 and gears 403 and a motor drive shaft is fixedly connected to rotor 400. In some embodiments, the rotational input is fixedly connected to motor shaft 405 and housing or base 401 is fixedly connected to rotor 400.

Rotational input speed is applied from prime mover 406 through drive shaft 410 to base 401 of motor 408 and a rotational output speed is applied from motor drive shaft 405 to rotor 400, i.e., rotor blades 404. The rotational output speed includes a speed of zero RPMs.

In an exemplary embodiment, input drive shaft 410 is connected to base 401 (rotor or stator) of motor 408 via bevel gear 403, to drive motor 408 at 100 percent of the rotational input speed (RPM) of bevel gear 403. If 100 percent rotor speed is desired, for example for anti-torque thrust, motor 408 remains magnetically locked and no additional power is supplied to motor 408 and motor 408 does not supply additional rotational speed to rotor 400. If rotational speed is needed in excess of the 100 percent input speed provided by drive shaft 410, motor 408 is powered to apply rotational speed in the same direction as bevel gear 403 resulting in higher rotor speed than the input rotational speed at bevel gear 403. Additional power may be desired, for example for an anti-torque rotor, during sideward flight conditions. If rotor 400 needs less than 100 percent of the input rotational speed, for example during forward cruise flight, motor 408 is unlocked allowing slippage and effectively slowing the rotor rotational speed and resulting in electric motor 408 operating as a generator to charge batteries 32 (FIG. 1) and/or to run accessory equipment.

Motor 408 can be operated in reverse to reduce rotational speed output through motor shaft 405 to rotor blades 404 relative to the input rotational speed, to stop rotation of rotor blades 404, or reverse the thrust direction of rotor blades 404. For example, with reference in particular to anti-torque rotors 400, it may be desired to reduce or stop rotation of rotor blades 404, for example to reduce noise during flight, or for safety when on the ground. To reduce the rotational speed of rotor blades 404, power, e.g., current, hydraulic fluid, supplied to motor 408 may be reduced to a level where the aerodynamic load on rotor blades 404 will drive motor 408 in a reverse direction relative to input drive shaft 410, thus allowing power to be extracted from motor 408. Such operation results in a rotor rotational speed less than the rotational speed input by prime mover 406 and drive shaft 410. To completely stop the rotation of rotor 400, a low level of power may be applied to motor 408 to drive motor 408 in a reverse direction relative to drive shaft 410 and at a rotational speed equal to the rotational speed of bevel gear 403 as supplied by prime mover 406 and drive shaft 410. To provide reverse thrust, power is supplied to motor 408 to drive motor 408 at a reverse rotational speed greater than the input rotational speed of bevel gear 403 as driven by drive shaft 410.

An exemplary hybrid aircraft rotor propulsion system combines a combustion engine mechanically connected to rotate a motor housing, and a motor shaft connected to a rotor. The combustion engine applies an approximately constant rotational input speed to the motor housing. By regulating the motor current, the rotor RPM can be precisely controlled, or completely stopped. If the desired rotor RPM is higher than the rotational speed of the mechanically-driven motor housing, then the additional power is supplied by the electric motor. If the desired rotor RPM is less than the rotational speed of the mechanically-driven motor housing, then the motor can be used to generate electrical power.

An exemplary method of controlling a rotational speed of an aircraft rotor includes applying a rotational input speed through a drive shaft to a motor and applying a rotational output speed to the aircraft rotor through the motor. This hybrid system provides full rotor RPM control with the majority of the power being supplied by the mechanical drive. The hybrid design eliminates the need for a much heavier, high power electric motor that would otherwise be required to power the rotor if an all-electric direct rotor drive is used.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

What is claimed is:

1. An aircraft rotor propulsion system, the system comprising:
a motor having a rotational output connected to a rotor; and
a prime mover connected to the motor through a rotational input, the prime mover configured to apply a rotational input speed to the motor.

2. The system of claim 1, wherein the motor is a hydraulic motor.

3. The system of claim 1, wherein the motor is an electric motor.

4. The system of claim 1, wherein the prime mover the prime mover is one selected from a combustion engine and an electric motor; and
the rotor is an anti-torque rotor.

5. The system of claim 4, wherein the motor is a hydraulic motor.

6. The system of claim 4, wherein the motor is an electric motor.

7. A method of controlling a rotational speed of an aircraft rotor, the method comprising:
applying a rotational input speed from a prime mover to a motor; and
applying a rotational output speed from the motor to the aircraft rotor.

8. The method of claim 7, wherein the rotational output speed is greater than the rotational input speed.

9. The method of claim 7, wherein the rotational output speed is one of zero, less than the rotational input speed, or in an opposite direction from the rotational input speed.

10. The method of claim 7, wherein the rotational output speed is substantially equal to the rotational input speed.

11. The method of claim 7, wherein the motor is one of an electric motor or a hydraulic motor; and
the prime mover is one of a combustion engine or an electric motor.

12. The method of claim 11, further comprising operating the motor at a speed greater than the rotational input speed and whereby the rotational output speed is greater than the rotational input speed.

13. The method of claim 11, wherein the motor is an electric motor, and further comprising driving the electric motor to generate electricity, whereby the rotational output speed is less than the rotational input speed.

14. The method of claim 11, further comprising operating the motor in an opposite direction from the rotational input speed whereby the rotational output speed is less than the rotational input speed.

15. The method of claim 11, further comprising operating the motor in an opposite direction from the rotational input speed whereby the rotational output speed is in the opposite direction from the rotational input speed.

16. A method of controlling a rotational speed of an aircraft rotor, the method comprising:
applying, from a prime mover, a rotational input speed through a drive shaft to a motor; and
applying a rotational output speed to an anti-torque rotor through the motor.

17. The method of claim 16, further comprising operating the motor in a direction opposite the rotational input speed.

18. The method of claim 16, further comprising locking the motor whereby the rotational output speed is approximately equal to the rotational input speed.

19. The method of claim 16, further comprising:
locking the motor whereby the rotational output speed is approximately equal to the rotational input speed; and
slipping the motor whereby the rotational output speed is less than the rotational input speed.

20. The method of claim 19, further comprising operating the motor in a same direction as the rotational input speed whereby the rotational output speed is greater than the rotational input speed.
